(19) United States
(12) Patent Application Publication
(10) Pub. No.: US 2015/0246733 A1
(43) Pub. Date: Sep. 3, 2015

(54) DEVICE AND METHOD FOR SUPPLYING NON-PROPULSIVE POWER FOR AN AIRCRAFT

(71) Applicant: MICROTURBO, Toulouse (FR)

(72) Inventors: Fabien Silet, Pechbonnieu (FR); Jean-Francois Rideau, Tournefeuille (FR)

(73) Assignee: MICROTURBO, TOULOUSE (FR)

(21) Appl. No.: 14/427,625

(22) PCT Filed: Sep. 10, 2013
(86) PCT No.: PCT/FR2013/052072

§ 371 Date: Mar. 11, 2015

(30) Foreign Application Priority Data
Sep. 17, 2012 (FR) 1258682

(51) Int. Cl. B64D 41/00

(52) U.S. Cl. CPC B64D 41/00

(57) ABSTRACT

Method for supplying non-propulsive power for an aircraft, comprising the driving of a shaft (13) of an environmental control system (1) of the aircraft by a combination of energy sources selected from:
an auxiliary power unit (4),
a starter/generator (18), and
auxiliary-air supply means (63).

### GENERAL TECHNICAL FIELD AND PRIOR ART

The present invention relates to the field of the supply of non-propulsive power for an aircraft, including the production of electrical and pneumatic power, affording the pressurisation and air-conditioning of a cabin for passengers on an aircraft. The temperature and pressure regulation of a passenger cabin is conventionally achieved by a system known to a person skilled in the art as an ECS, standing for “environmental control system”. When the main engines of the aircraft are stopped, the supply of pneumatic and/or electrical power is provided by an auxiliary power unit known to a person skilled in the art as an APU, standing for “auxiliary power unit”.

In a simplified manner, with reference to FIG. 1A, an ECS 1 is able to take an ambient air flow A_{amb} to the aircraft at external pressure P0 and external temperature T0 in order to cool it or heat it before distributing it in a passenger cabin 2. In practice, with reference to FIG. 1A, an ECS 1 comprises a load compressor 11 and a turbine 12 connected by a connecting shaft 13, a heat exchanger 14 and a condenser 15.

In functioning, the ECS 1 takes the air A_{M} from the main engines of the aircraft in order to set the load compressor 11 into rotation. The load compressor 11 aspirates ambient air A_{amb} via a supply valve 17 and compresses it in the heat exchanger 14 in order to regulate its temperature and then in the condenser 15 in order to dehumidify it. The cooled air flow then expands in the cold turbine 12 before being routed into the passenger cabin 2, as illustrated in FIG. 1A.

Optionally, after circulation in the passenger cabin 2, the air in the passenger cabin 2 can be introduced into a mixer 16 together with the ambient air A_{amb}, the mixture then being aspirated by the load compressor 11 in order to improve the efficiency of the ECS 1 by limiting the quantity of air A_{M} taken from the main engines.

The ECS 1 taking power from the main engines is detrimental firstly to the fuel consumption of the aircraft and secondly to the configuration of the main engines, which must be able to cooperate with the ECS 1. In practice, for reasons of reliability, the ECS 1 is duplicated in an aircraft, which increases the constraints relating to the main engines.

With reference to FIG. 1B, it has been proposed to drive the ECS 1 by means of an electric motor 3 in order to avoid taking power from the main engines of the aircraft. Nevertheless such an electric drive has low energy efficiency, which is a drawback.

### BRIEF DESCRIPTION OF THE INVENTION

In order to eliminate at least some of these drawbacks, the invention relates to a method for supplying non-propulsive power for an aircraft, comprising the driving of a shaft of a system controlling the environment of the aircraft by a combination of energy sources selected from:
an auxiliary power unit,
a starter/generator, and
auxiliary-air supply means.

According to the invention, the environmental control system ECS can be activated by a plurality of energy sources, such as pneumatic and electrical sources. The auxiliary power unit APU may for example supply pneumatic energy (by delivering an air flow) and/or electrical energy (for example when it is equipped with a starter/generator). In a particular embodiment of the invention, the APU supplies pneumatic energy to the ECS and comprises a starter/generator that supplies electrical energy to a starter/generator of the ECS, in order to transmit a power boost to said ECS.

The starter/generator is able to supply electrical energy and the auxiliary-air supply means are able to supply pneumatic energy.

The invention thus makes it possible to operate the ECS according to a plurality of modes, which will be described in detail hereinafter.

The auxiliary power unit can generate an air flow driving a free turbine rigidly connected to the shaft of the environmental control system.

When functioning as starter, the starter/generator can be supplied with electricity by electrical supply means, such as electrical ground equipment of an airport, or the electrical system of the aircraft. In a variant or in addition, it may be supplied with electricity by a generator/starter of the auxiliary power unit.

The means for supplying auxiliary air may drive a free turbine rigidly connected to the shaft of the environmental control system. They may be formed by the main engines of the aircraft or by air-supply ground equipment of an airport.

The invention also relates to a device for supplying non-propulsive power for an aircraft, the device comprising:
an auxiliary power unit comprising a power compressor, a combustion chamber, and a power turbine connected to said power compressor by a power shaft; and
an environmental control system that comprises a turbine for distributing regulated air intended for an aircraft cabin and a load compressor connected to the distribution turbine by a connecting shaft,
   the environmental control system comprising a free driving turbine rigidly connected to the connecting shaft, and the environmental control system and the auxiliary power unit being configured so that the power turbine supplies an air flow to the free driving turbine so as to drive the load compressor rigidly connected to the connecting shaft.

The device according to the invention is self-contained and includes the functions of an auxiliary power unit APU, and also of an environmental control system ECS, which is advantageous.

Conventionally, an aircraft comprises an auxiliary power unit, known by the abbreviation APU, standing for “auxiliary power unit”, in order to supply pneumatic or electrical power to the equipment of the aircraft when said aircraft is on the ground and its turbojet engines are not in operation. During the flight of the aircraft, the APU is not used and is considered to be a “dead weight”.

Advantageously, the power unit and the environmental control system are coupled so as firstly to limit take-off from the main engines of the aircraft and secondly to fully use the capacities of the APU, which were traditionally used only at start-up. Furthermore, the APU makes it possible to supplement the supply of the ECS, which no longer needs to be necessarily duplicated. The efficiency of the aircraft is thus improved.

The APU and the ECS are traditionally considered to be distinct functional modules, that is to say devoid of interactions. This technical prejudice results in concrete terms in a clear differentiation in the specificities of aircraft constructors, who consider the APU and the ECS to belong to different and quite distinct functional classes. The APU and the ECS belong respectively to the functional classes ATA 49 and class ATA 21, well known to a person skilled in the art.

The invention is distinctive in that the known device further comprises at least one of the following energy sources:
an accessory starter/generator suitable for setting the connecting shaft into rotation, and
means for supplying auxiliary air arranged to set into rotation the free turbine driving the environmental control system so as to drive the load compressor rigidly connected to the connecting shaft.

The invention is particularly advantageous since it makes it possible to activate the environmental control system by means of a plurality of different sources, which may be used independently of one another or in combination with one another.

In a first case, the connecting shaft of the ECS may be set into rotation by (i) the APU or (ii) the starter/generator of the ECS, said starter/generator being able to be connected to electrical supply means.

In a second case, the connecting shaft for the ECS may be set into rotation by (i) the APU or (iii) the compressed air supply means.

In a third case, corresponding to the combination of the first two cases, the connecting shaft of the ECS may be set into rotation by (i) the APU, (ii) the starter/generator of the ECS or (iii) the compressed air supply means.

In other words, the invention proposes a device that is configured so as to be able to choose the activation source for the ECS from at least two available sources. This makes it possible to operate the device according to a plurality of modes, including:
the self-contained operating mode A, in which the power turbine of the APU supplies an air flow to the free turbine driving the ECS so as to drive the load compressor rigidly connected to the connecting shaft,
the electrical operating mode E, in which the connecting shaft is set into rotation by the generator/starter of the ECS, which is for example connected to an auxiliary electrical source, and
the pneumatic operating mode P, in which the supply means (the auxiliary pneumatic source) supply compressed air to the free turbine driving the ECS so as to drive the load compressor rigidly connected to the connecting shaft.

Preferably, the non-propulsive power device is mounted in the same housing of an aircraft. Thus the cooperation between the APU and the ECS is not only functional but also physical in order to be able to reduce the space requirement of the regulation device while allowing a high-efficiency coupling.

Preferably, the power turbine and the free turbine are separated by a distance of less than 30 cm so as to allow an efficient pneumatic coupling.

Preferably, the auxiliary power unit comprises a starter/power generator suitable for setting the power shaft into rotation. Preferably again, the starter/power generator is suitable for generating electrical energy when the power turbine is rotated.

The starter/generator thus makes it possible to start the APU and to supply surplus electrical power to the ECS should additional compressed air be required. In addition, the starter/generator advantageously makes it possible to store electrical energy during the self-contained operating of the APU, which improves the energy efficiency of the regulation device.

Preferably, the secondary starter/generator of the environmental control system is electrically connected to the auxiliary power unit, preferably to the starter/power generator. Thus the secondary starter/generator makes it possible to supply surplus energy to the ECS according to compressed air requirements (referred to as operating mode T).

According to a preferred aspect of the invention, the regulation device comprises means for venting the free driving turbine so as to allow rotation of the free driving turbine when the ECS is supplied by auxiliary energy sources other than the auxiliary power unit.

Preferably, the free driving turbine is directly mounted in the vicinity of the load compressor on the connecting shaft, which makes it possible to limit the bulk and complexity of the ECS.

The invention further relates to a method for regulating an aircraft cabin for passengers, by means of a system as described above, in which the connecting shaft is driven by at least one of the following energy sources:
the auxiliary power unit, the free turbine of which supplies an air flow to the free driving turbine so as to drive the load compressor rigidly connected to the connecting shaft,
the secondary starter/generator of the environmental control system, and
the supply means that supply an auxiliary air flow to the free driving turbine of the environmental control system so as to drive the load compressor rigidly connected to the connecting shaft.

### BRIEF DESCRIPTION OF THE FIGURES

The invention will be better understood upon reading the following description, given solely by way of example, and referring to the accompanying drawings, in which:

FIG. 1A is a simplified schematic representation of an ECS according to the prior art driven by air A_{M} from the main engines of the aircraft (already commented on);

FIG. 1B is a simplified schematic representation of an ECS according to the prior art driven by a dedicated electric motor (already commented on);

FIG. 2 is a schematic representation of a device supplying non-propulsive power for an aircraft according to the invention comprising an ECS coupled to an auxiliary power unit;

FIG. 3 is a schematic representation of the device supplying non-propulsive power according to the invention according to a first embodiment (MODE-A) in which the operating of the device is self-contained;

FIG. 4 is a schematic representation of the device supplying non-propulsive power according to the invention according to a second embodiment (MODE-T) in which the auxiliary power unit supplies pneumatic energy and electrical energy for driving the ECS;

FIG. 5 is a schematic representation of the device supplying non-propulsive power according to the invention according to a third embodiment (MODE-E) in which the device is supplied by an auxiliary electrical source, the auxiliary power unit not being active; and

FIG. 6 is a schematic representation of the device supplying non-propulsive power according to the invention according to a fourth embodiment (MODE-P) in which the device is supplied by an auxiliary pneumatic source, the auxiliary power unit not being active.

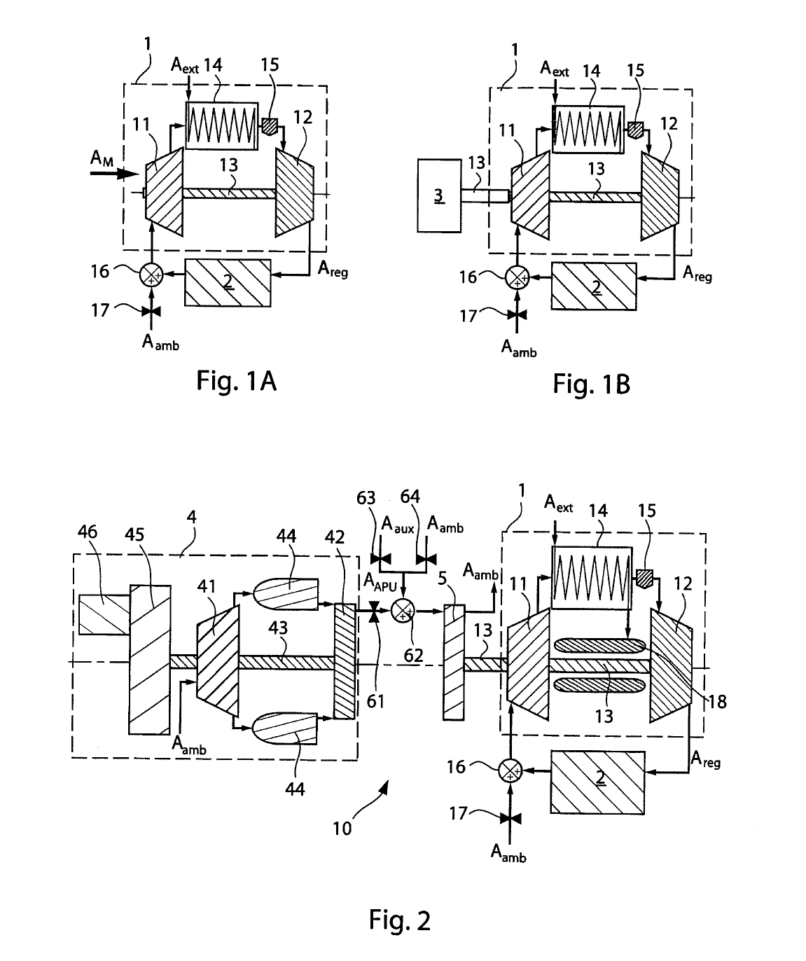

It should be noted that the figures disclose the invention in detail for implementing the invention, said figures being able of course to serve to better define the invention where applicable.

### DESCRIPTION OF ONE OR MORE EMBODIMENTS AND IMPLEMENTATIONS.

The invention will be described for an aircraft comprising one or more main engines in order to move the aircraft. The aircraft further comprises a cabin for passengers that must be regulated for pressure and/or temperature. With reference to FIG. 2, a device 10 supplying non-propulsive power will be described.

The device 10 supplying non-propulsive power comprises an environmental control system 1, known to a person skilled in the art by the term ECS, and an auxiliary power unit 4, known to a person skilled in the art by the term APU. According to the invention, the ECS 1 and the APU 4 are coupled so that the APU 4 supplies power to the ECS unit 1 and thus reduces the power take-off thereof from the main engines of the aircraft.

ECS 1

As shown in FIG. 2, the ECS 1 comprises a turbine 12 for distributing regulated air A_{reg} intended for the aircraft cabin 2 and a load compressor 11 connected to the distribution turbine 12 by a connecting shaft 13. Preferably, the ECS 1 comprises a heat exchanger 14 and a condenser 15 so that the ambient air A_{amb} taken by the load compressor 11 via supply means 17 can be regulated for temperature by the heat exchanger 14 and dehumidified by the condenser 15 in order to obtain a regulated air flow A_{reg} able to be introduced into the passenger cabin 2.

Preferably, the ECS 1 comprises a secondary starter/generator 18 mounted on the connecting shaft 13 of the ECS 1 so as to be able firstly to set the connecting shaft 13 into rotation when functioning as starter using its reserves of electrical energy, and, secondly, to accumulate electrical energy when the connecting shaft 13 is rotated when functioning as “generator”). Advantageously, when functioning as starter, the secondary starter/generator 18 makes it possible to precisely regulate the pressurised air supply to the passenger cabin 2.

In this example, the supply means 17 are in the form of a supply valve 17 but it goes without saying that other means could be suitable. Preferably again, the ECS 1 comprises a mixer 16 suitable for mixing the ambient air flow A_{amb} from the supply valve 17 with an air flow from the passenger cabin 2. Such a recirculation of the air flow from the passenger cabin 2 makes it possible to advantageously improve the efficiency of the ECS 1.

APU 4

Still with reference to FIG. 2, the APU 4 of the non-propulsive power supply device 10 comprises a power compressor 41, a combustion chamber 44 and a power turbine 42 connected to said power compressor 41 by a power shaft 43. In other words, the APU 4 forms a gas generator and affords the electrical and/or pneumatic supply to equipment of the aircraft.

Preferably, the APU 4 comprises a starter/power generator 46 mounted on the power shaft 43 of the APU 4 so as to be able firstly to set the power shaft 43 into rotation when functioning as “starter” using its electrical energy reserves, and secondly to accumulate electrical energy when the power shaft 43 is rotated.

Preferably, the starter/power generator 46 is mounted on the power shaft 43 by means of a relay box 45, that is to say a multiplier, so as to adapt the rotation speed of the power shaft 43 to that of the starter/power generator 46. Thus the starter/power generator 46 can be driven by the power shaft 43 in order to generate electrical energy or drive the power shaft 43, that is to say generate mechanical energy from electrical energy.

According to one aspect of the invention, the secondary starter/generator 18 of the ECS 1 is electrically connected to the APU 4, preferably to the starter/power generator 46 thereof, so as to allow electrical driving of the connecting shaft 13 of the ECS 1, as will be detailed below. Moreover, the secondary starter/generator 18 of the ECS 1 can also be electrically connected to electrical ground equipment of an airport, as will be detailed hereinafter.

As the APU and the ECS each have a starter/generator 18, 46, the speed of each shaft can be freely regulated in order to adapt reactively to the requirements of the non-propulsive power supply device 10.

Conventionally, such an APU 4 is used only during phases on the ground, that is to say before the main engines of the aircraft are actually started, and after stoppage thereof. The APU 4 and ECS 1 are conventionally separate devices that do not interact with each other when the aircraft is in flight. According to the invention, the APU 4 and the ECS 1 cooperate during a flight of the aircraft in order to limit the times when power is taken from the main engines of the aircraft and thus increase the energy efficiency of the aircraft. In addition, this makes it possible to form a device of limited size and mass.

According to the invention, the ECS 1 comprises a free driving turbine 5 rigidly connected to the connecting shaft 13 as shown in FIG. 2. The ECS 1 and the APU 4 are configured so that the power turbine 42 supplies an air flow A_{APU} to the free driving turbine 5 so as to drive the load compressor 11 rigidly connected to the connecting shaft 13.

The air expelled from the combustion chamber 44 of the APU 4 expands in the power turbine 42 and then in the free turbine 5 as shown in FIG. 2. Thus, the energy from the combustion chamber 44 participates firstly in the driving of the power compressor 41 of the APU4 and secondly in the driving of the load compressor 11 of the ECS 1.

Preferably, the non-propulsive power supply device 10 comprises means 63 for supplying auxiliary air Aₐᵤₓ to the free turbine 5. Auxiliary air Aₐᵤₓ means an air flow, for example from the main engines of the aircraft or supplied by ground equipment of an airport. In this example, the means 63 supplying auxiliary air Aₐᵤₓ are in the form of a supply valve. Preferably, the regulation device 10 comprises means 64 for venting the free turbine 5 when the APU 4 is not activated. In this example, the venting means 64 are in the form of a venting valve.

Preferably again, the non-propulsive power supply device 10 comprises a mixer 62 arranged so as to mix an air flow from the means 63 supplying auxiliary air Aₐᵤₓ, an air flow from the venting means 64 and an air flow A_{APU} from the power turbine 42. Preferably, the non-propulsive power supply device 10 comprises means 61 for regulating the air flow A_{APU} supplied by the power turbine 42 to the mixer 62, preferably a regulation valve.

The invention intends to combine the APU 4 and the ECS 1 in order to form a non-propulsive power supply device 10 having low mass and limited bulk.

According to one aspect of the invention, the APU 4 and the ECS 1 belong to the same housing in the aircraft, the housing being able to be a single unit or compartmented. Preferably, the power turbine 42 of the APU 4 and the free turbine 5 of the ECS 1 are separated by a distance of less than 30 cm, preferably of approximately 5 cm. The proximity of the power turbine 42 of the APU 4 to the free turbine 5 of the ECS 1 makes it possible to effectively profit from the expansion of the gases from the combustion chamber 44 of the APU. Preferably, the free driving turbine 5 is directly mounted in the vicinity of the load compressor 11 on the connecting shaft 13, that is to say without any intermediary, so as to limit the bulk and complexity of the non-propulsive power supply device 10.

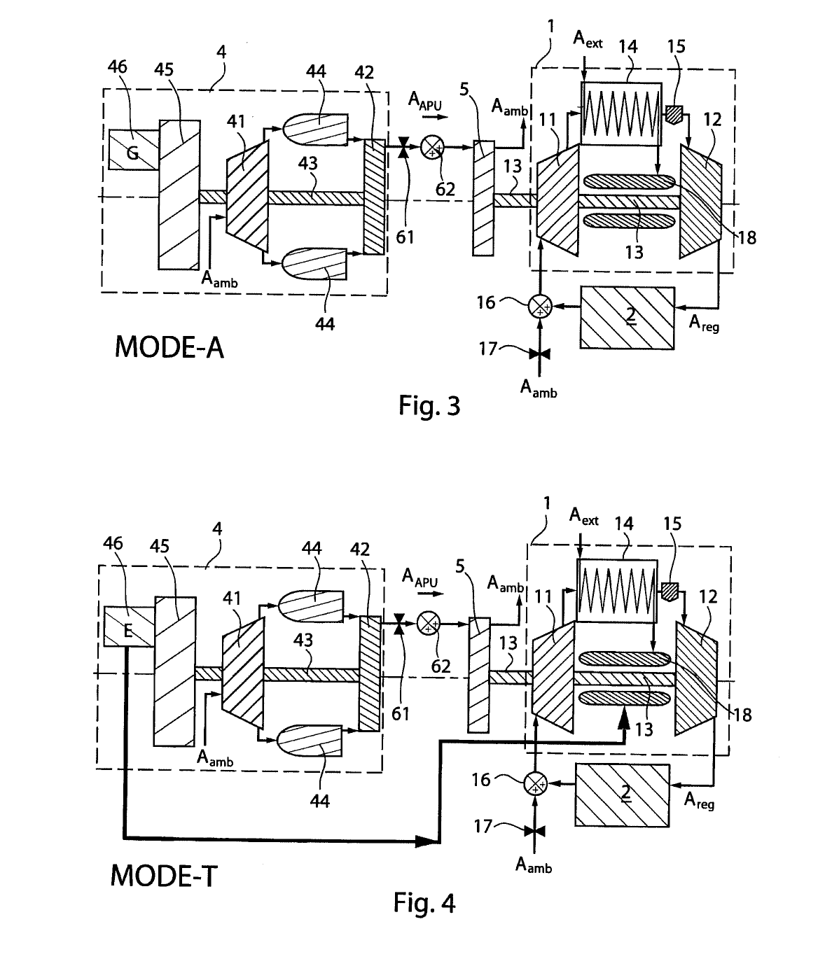

The invention will be better understood with reference to FIGS. 3 to 6, which show various embodiments of the invention.

Self-Contained Operating (MODE-A)

With reference to FIG. 3, in self-contained operating, the APU 4 is active. The power compressor 41 aspirates ambient air A_{amb} that is conducted and compressed in the combustion chamber 44. The gases from the combustion chamber 44 are expanded in the power turbine 42. Downstream of the power turbine 42, an air flow A_{APU} is received by the free driving turbine 5 in order to drive the load compressor 11 of the ECS 1 by means of the connecting shaft 13. In other words, advantage is taken of the energy from the air flow A_{APU} for supplying energy to the ECS 1 and thus avoid taking energy from the main engines of the aircraft.

The load compressor 11 aspirates external air A_{amb} via the supply means 17, which air is conducted and compressed in the exchanger 14 and cooled by an external air flow Aₑₓₜ. Once cooled, the air flow is dried by the condenser 15 before being expanded in the distribution turbine 12 in order then to be conducted into the passenger cabin 2. Recirculated air from the passenger cabin 2 can also be taken off by the load compressor 11. The mixer 16 can also adapt to the proportion of ambient air A_{amb} in the air aspirated by the load compressor 11.

Advantageously, during MODE-A, the starter/power generator 46 of the APU 4, after having served for starting the assembly, can supply electrical energy by means of the relay box 45. Preferably, the starter/power generator 18 of the ECS 1 can also supply electrical energy.

In this example, the auxiliary-air supply means 63 and the venting means 64 are closed.

In self-contained operating MODE-A, the ECS 1 is supplied pneumatically by the APU 4. This pneumatic energy is transformed by the free driving turbine 5 into a rotation of the connecting shaft 13. The APU is thus used during the starting of the aircraft but also during flight.

Operating with Transfer of Electrical Energy (MODE-T)

With reference to FIG. 4, in electrical energy transfer operating, the APU 4 is active and the gases from the combustion chamber 44 are expanded in the power turbine 42. In a similar manner to MODE-A, downstream of the power turbine 42, an air flow A_{APU} is received by the free driving turbine 5 in order to drive the load compressor 11 by means of the connecting shaft 13.

Advantageously, during MODE-T, the starter/power generator 46 electrically supplies the secondary starter/generator 18 of the ECS 1 so as to accelerate the driving speed of the connecting shaft 13. In other words, if the ECS 1 requires, for particular conditions, a large amount of energy, the starter/power generator 46 can supply electrical energy, which supplements the pneumatic energy supplied by the power turbine 42, which is highly advantageous. The connecting shaft 13 thus receives a temporary power boost, which is advantageous in the flight phases of the aircraft where the pressurised air requirements are high (so-called “pull-up” or “pull-down” phases).

In this example, the auxiliary-air supply means 63 and the venting means 64 are closed.

In self-contained operating MODE-A, the ECS 1 is supplied pneumatically and electrically by the APU 4. Advantageously, it is not necessary to oversize the non-propulsive power supply device 10 in order to respond to transient forces, the surplus electrical energy supplied by the APU 4 making it possible to absorb the transient forces.

Electrical Operating (MODE-E)

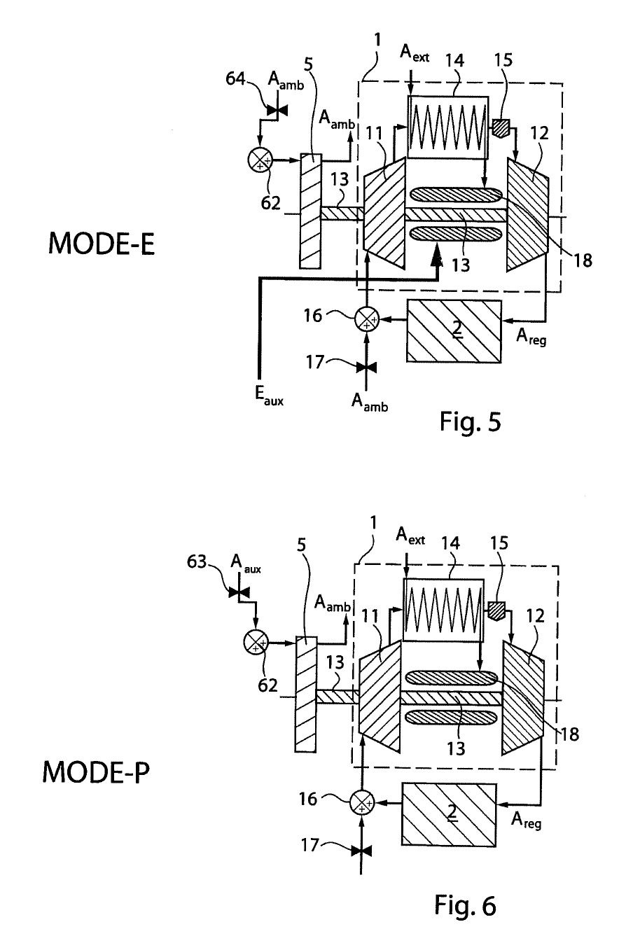

With reference to FIG. 5, in electrical operating, the APU 4 is inactive. The ECS 1 is driven by the secondary starter/generator 18, which is supplied electrically by an auxiliary electrical source Eₐᵤₓ, for example electrical ground equipment of an aircraft.

Thus, during operating in electrical mode, the connecting shaft 13 is driven by the auxiliary electrical source Eₐᵤₓ. Since the free driving turbine 5 is rigidly connected to the connecting shaft 13, it is important to vent the free driving turbine 5 in order to prevent any malfunctioning in the absence of air supply to the APU 4. To this end, the venting valve 64 is open in electrical operating while the auxiliary-air supply means 63 remain closed.

In electrical operating MODE-E, the ECS 1 is supplied electrically by an auxiliary electrical source Eₐᵤₓ, which is advantageous and does not take resources particular to the aircraft.

Pneumatic Operating (MODE-P)

With reference to FIG. 6, in pneumatic operating, the APU 4 is inactive. The ECS 1 is driven by the free driving turbine 5 via an auxiliary pneumatic source Aₐᵤₓ, for example ground equipment of an airport supplying compressed air.

Thus, during operating in pneumatic mode, the free driving turbine 5 is driven by the auxiliary pneumatic source Aₐᵤₓ. For this purpose, the auxiliary-air supply means 63 are open in pneumatic operating while the venting means 64 remain closed.

In pneumatic operating MODE-P, the ECS 1 is supplied pneumatically by an auxiliary pneumatic source Aₐᵤₓ. This pneumatic power source may be external to the aircraft (ground equipment of an airport for example) or come from a compressed air source integrated in the aircraft (main engines, cabin pressurisation recovery, etc.).

1. Method for supplying non-propulsive power for an aircraft, comprising the driving of a shaft of an environmental control system of the aircraft by a combination of energy sources selected from:
an auxiliary power unit,
a starter/generator, and
auxiliary-air supply means.

2. Method according to claim 1, wherein the auxiliary power unit generates an air flow for driving a free turbine rigidly connected to the shaft of the environmental control system.

3. Method according to claim 1, wherein the starter/generator is, when functioning as starter, supplied with electricity by electrical supply means, such as electrical ground equipment of an airport, or the electrical system of the aircraft.

4. Method according to claim 1, wherein the starter/generator is, when functioning as starter, supplied with electricity by a generator/starter of the auxiliary power unit.

5. Method according to claim 1, wherein the auxiliary-air supply means drive a free turbine rigidly connected to the shaft of the environmental control system.

6. Method according to claim 1, wherein the auxiliary-air supply means are formed by the main engines of the aircraft or by air-supply ground equipment of an airport.

7. Device for supplying non-propulsive power for an aircraft, the device comprising:
an auxiliary power unit comprising a power compressor, a combustion chamber and a power turbine connected to said power compressor by a power shaft;
an environmental control system that comprises a turbine for distributing regulated air (A_{reg}) intended for an aircraft cabin and a load compressor connected to the distribution turbine by a connecting shaft;
the environmental control system comprising a free driving turbine rigidly connected to the connecting shaft, and the environmental control system and the auxiliary power unit being configured so that the power turbine supplies an air flow (A_{APU}) to the free driving turbine so as to drive the load compressor rigidly connected to the connecting shaft,
a device characterised in that it further comprises at least one of the following energy sources:
a secondary starter/generator suitable for setting the connecting shaft into rotation, and
auxiliary-air supply means arranged so as to set into rotation the free driving turbine of the environmental control system so as to drive the load compressor rigidly connected to the connecting shaft.

8. Device according to claim 7, wherein the non-propulsive power supply device is mounted in a same housing of an aircraft.

9. Device according to claim 7, wherein the power turbine and the free turbine are separated by a distance of less than 30 cm.

10. Device according to claim 7, wherein the power starter/generator is suitable for generating electrical energy when the power turbine is rotated.

11. Device according to claim 7, wherein the environmental control system comprises a secondary starter/generator suitable for setting the connecting shaft into rotation.

12. Device according to claim 11, wherein the secondary starter/generator of the environmental control system is electrically connected to the auxiliary power unit.

13. Device according to claim 7, comprising means for venting the free driving turbine.

14. Device according to claim 7, wherein the free driving turbine is directly mounted in the vicinity of the load compressor on the connecting shaft.

15. Method for supplying non-propulsive power for an aircraft by means of a device according to claim 7, wherein the connecting shaft is driven by at least one of the following energy sources:
the auxiliary power unit, the power turbine of which supplies an air flow (A_{APU}) to the free driving turbine so as to drive the load compressor rigidly connected to the connecting shaft, or
the secondary starter/generator of the environmental control system, and
the supply means that supply an auxiliary air flow to the free driving turbine of the environmental control system so as to drive the load compressor rigidly connected to the connecting shaft.
